(19) United States
(12) Patent Application Publication
(10) Pub. No.: US 2024/0200512 A1
(43) Pub. Date: Jun. 20, 2024

(54) METHOD FOR OPERATING AN AMMONIA COMBUSTION ENGINE, AMMONIA COMBUSTION ENGINE, AND MOBILE OR STATIONARY SYSTEM

(71) Applicant: HUG Engineering AG, Elsau (CH)

(72) Inventors: Dominik GSCHWEND, Elsau (CH); Felix SEITZ, Elsau (CH); Christian LIEBER, Elsau (CH); Simon SCHIEGG, Elsau (CH); Jan TE HEESEN, Elsau (CH); Daniel PEITZ, Elsau (CH)

(21) Appl. No.: 18/538,467

(22) Filed: Dec. 13, 2023

(30) Foreign Application Priority Data
Dec. 16, 2022 (DE) 10 2022 133 656.5

(51) Int. Cl. F02M 21/02; F02D 41/00; F02D 41/14

(52) U.S. Cl. CPC F02M 21/0206; F02D 41/0027; F02D 41/1461

(57) ABSTRACT

An ammonia combustion engine, a mobile or stationary system having an ammonia combustion engine, and a method comprise operating an ammonia combustion engine with a combustion chamber and an injection device which is in fluidic connection with the combustion chamber. The ammonia can be metered into the combustion chamber. Ammonia is metered into the combustion chamber such that an exhaust gas stream generated by the ammonia combustion engine has a predetermined molar ratio of ammonia to nitrogen oxides independently of the current operating point of the ammonia combustion engine.

### CROSS-REFERENCE TO RELATED APPLICATION

This application is a U.S. non-provisional application claiming the benefit of German Application No. 10 2022 133 656.5, filed on Dec. 16, 2022, which is incorporated herein by reference in its entirety.

### TECHNICAL FIELD

The disclosure relates to a method for operating an ammonia combustion engine, an ammonia combustion engine, and a mobile or stationary system comprising an ammonia combustion engine.

### BACKGROUND

Ammonia combustion engines are internal combustion engines which use ammonia as fuel and represent an alternative to “classic” internal combustion engines that use hydrocarbons such as natural gas, gasoline, or diesel as fuel. The use of ammonia combustion engines is particularly desirable if hydrocarbons from fossil sources are at least partially replaced by ammonia with a lower CO₂ footprint as the fuel. This is advantageous even if fuels other than ammonia are still being used for ignition or combustion of the ammonia. In addition, many ammonia combustion engines are able to utilize various fuels, that is to say can also continue to be operated with other fuels in addition to ammonia.

However, ammonia combustion engines generate exhaust gas streams that are fundamentally different from those that occur in a classic internal combustion engine. The problem that arises here is that, depending on the operating point, design and tuning of the ammonia combustion engine, an exhaust gas stream is generated which may have an excess of nitrogen oxides (NOₓ) or ammonia (NH₃). This places high requirements on downstream exhaust gas aftertreatment systems since these must be designed for both situations, as a result of which the complexity and costs of the exhaust gas aftertreatment of ammonia combustion engines are high.

### SUMMARY

The subject disclosure provides an option for reducing the complexity and/or the costs of the exhaust gas aftertreatment of an exhaust gas stream generated in an ammonia combustion engine.

The disclosure provides a method for operating an ammonia combustion engine with a combustion chamber and an injection device which is in fluidic connection with the combustion chamber and with which ammonia can be metered into the combustion chamber, wherein ammonia is metered into the combustion chamber such that an exhaust gas stream generated by the ammonia combustion engine has a predetermined molar ratio of ammonia to nitrogen oxides independently of the current operating point of the ammonia combustion engine.

The “operating point” of the ammonia combustion engine denotes a certain point in the characteristic diagram of the particular ammonia combustion engine. Accordingly, the current operating point is the point in the characteristic diagram of the ammonia combustion engine which exists at the current point in time. The current operating point is thus also an expression of the combustion conditions in the ammonia combustion engine.

Here and below, the term “molar ratio” refers to the molar ratio of ammonia to nitrogen oxides, unless stated otherwise.

The disclosure is based on the fundamental idea of actively controlling or adjusting the molar ratio in the generated exhaust gas stream such that a previously defined and thus sufficiently known molar ratio of ammonia to nitrogen oxides is generated in the exhaust gas stream at any time. In this way, an exhaust gas aftertreatment system downstream of the ammonia combustion engine has to be tuned or aligned solely to the predetermined molar ratio, as a result of which the complexity and design and thus the costs of the exhaust gas aftertreatment system can be minimized.

The predetermined molar ratio of ammonia to nitrogen oxides denotes, in particular, the molar ratio of ammonia to nitrogen oxides in the exhaust gas stream at an outlet of the ammonia combustion engine, for example, at the end of a discharge line of the ammonia combustion engine that is in fluidic connection with the combustion chamber. In other words, the predetermined molar ratio is, in particular, the molar ratio of ammonia to nitrogen oxides, which the exhaust gas stream has that is generated by the ammonia combustion engine before treatment with an exhaust gas aftertreatment system downstream of the ammonia combustion engine.

However, it is also possible that the molar ratio of ammonia to nitrogen oxides is used as a predetermined molar ratio of ammonia to nitrogen oxides that the exhaust gas stream has before the exhaust gas stream is treated in an actively controlled component of the exhaust gas aftertreatment system downstream of the ammonia combustion engine. Thus, passively operating components of the exhaust gas aftertreatment system can already have treated the exhaust gas stream.

In one variant, the predetermined molar ratio of ammonia to nitrogen oxides (R) is in the range of R:1 to 1.1×R:1, wherein R is a provided NOₓ reduction rate. In other words, the predetermined molar ratio is at most 1.1 times the provided NOₓ reduction rate. If the provided NOₓ reduction rate is, for example 80%, the predetermined molar ratio can be in the range of 0.8:1 to 0.88:1. The provided NOₓ reduction rate R can accordingly be less than 100%, for example, in the range of 80% to less than 100%.

In another variant, the predetermined molar ratio of ammonia to nitrogen oxides is 1:1 or higher. In particular, the predetermined molar ratio is in the range of 1:1 to 1.5:1.

In this variant, an excess of ammonia is thus selected in comparison with the content of nitrogen oxides in the exhaust gas stream, or at least a balance between ammonia and the nitrogen oxides to be reduced is selected. In other words, a so-called “ammonia slip” can be used in a targeted manner. It has been found that particularly advantageous operating points of ammonia combustion engines can be used if ammonia slip in the exhaust gas stream is accepted.

An advantage of ammonia slip in the exhaust gas stream is also that additional metering systems for metering ammonia into the exhaust gas stream can be dispensed with in a downstream exhaust gas aftertreatment system, or a metering area of the exhaust gas aftertreatment system of the additional metering system can be at least minimized. If an excess of nitrogen oxides would be present in the exhaust gas stream, such metering systems are necessary to convert them to nitrogen and water. The complexity, the costs, and the space requirement of the exhaust gas aftertreatment system can thus be further reduced, since either a metering system is dispensed with completely or at least more cost-effective metering systems can be provided with smaller metering areas and/or simpler components.

Furthermore, it is possible that a molar ratio is selected as a predetermined molar ratio, which is adjusted to be optimized for the degradation of nitrous oxide, since nitrous oxide (N₂O) is also contained in the exhaust gas stream in addition to ammonia.

Nitrous oxide is a by-product occurring at least some operating points of an ammonia combustion engine with a greenhouse gas potential that, in a time horizon of 100 years, corresponds to more than 250 times the greenhouse gas potential of carbon dioxide. It is thus crucial that nitrous oxide contained in the exhaust gas stream is reliably converted from the exhaust gas stream in the exhaust gas aftertreatment system.

For this purpose, the predetermined molar ratio can be selected such that the predetermined molar ratio is not optimized for the ammonia and nitrogen oxide exhaust aftertreatment, but is optimized for the removal of nitrous oxide from the exhaust gas stream. This can be done by having a molar ratio of ammonia to nitrogen oxides in the exhaust gas stream, which is adjusted to an N₂O decomposition catalytic converter arranged in the exhaust gas aftertreatment system so that the N₂O decomposition catalytic converter achieves an optimized reaction rate and selectivity.

In one variant, the method comprises the following steps:
a) determining the current operating point of the ammonia combustion engine,
b) determining an expected molar ratio of ammonia to nitrogen oxides in the generated exhaust gas stream at the current operating point,
c) comparing the expected molar ratio with the predetermined molar ratio, and
d) adapting the quantity of ammonia metered into the combustion chamber via the injection device if the expected molar ratio deviates from the predetermined molar ratio by more than a threshold value.

The threshold value is defined in particular such that the metered amount of ammonia is adjusted in the event of a deviation of more than 5% between expected molar ratio and predetermined molar ratio.

Steps a) to d) can be carried out in a control unit of the ammonia combustion engine, wherein the threshold value is stored in the control unit.

Steps a) to d) are preferably repeated continuously, so that any excessive deviations from the predetermined molar ratio can be detected promptly and still be compensated with minimum time delay.

“Continuously repeated” means in this context that, between two repetitions of the corresponding method steps, only the time absolutely necessary for carrying out the further method steps is maintained.

The expected molar ratio is determined in particular on the basis of a data set stored in a control unit of the ammonia combustion engine, wherein the data set is based on at least one piece of operating information on the behavior of the ammonia combustion engine.

At least one of the following pieces of information may be included in the operating information on the behavior of the ammonia combustion engine (also referred to as engine operating parameter): quantity of ammonia metered into the combustion chamber per unit of time, total quantity of ammonia metered into the combustion chamber in a combustion cycle, temporal distribution of the quantity of ammonia metered into the combustion chamber, charge air pressure, temperature, relative humidity, air-fuel ratio and ignition pressure.

The stored data record thus represents a “mapping” of the behavior of the ammonia combustion engine. The more extensive the stored data record is designed, the more precisely the expected molar ratio can be determined based on the data set.

In particular, the expected molar ratio can be determined completely passively on the basis of the stored data set, i.e., no additional actively measured parameters have to be incorporated into the determination of the expected molar ratio. This is advantageous, in particular, if the behavior of the ammonia combustion engine is sufficiently known at all relevant operating points and can be described sufficiently accurately via the operating information stored in the stored data set.

Alternatively or additionally, the ammonia combustion engine may have at least one sensor which samples the generated exhaust gas stream, wherein the expected molar ratio is determined on the basis of the sensor measurement data generated by the sensor during sampling. In this way, a particularly precise statement regarding the expected molar ratio of ammonia to nitrogen oxides can be obtained via an active checking of the composition of the generated exhaust gas stream. In particular, the metering of ammonia into the combustion chamber of the exhaust gas aftertreatment system can be adapted in a “closed loop” method based on the generated sensor measurement data.

It is also possible for a combination of the operating information present in the stored data set and sensor measurement data generated by the at least one sensor to be used for determining the expected molar ratio of ammonia to nitrogen oxides.

In addition, the control unit may have a machine learning module which is configured to adapt the at least one piece of operating information based on the sensor measurement data generated by the at least one sensor. In this way, detected deviations can be taken into account when using the ammonia combustion engine, so that the expected molar ratio of ammonia to nitrogen oxides can be determined reliably and precisely at any time.

The at least one sensor can be arranged both at a point in the exhaust gas stream at which the predetermined molar ratio of ammonia to nitrogen oxides must exist, and also at a point which only allows a conclusion to be drawn about the actual molar ratio of ammonia to nitrogen oxides at a different location in the exhaust gas stream at which the predetermined molar ratio of ammonia to nitrogen oxides must exist.

For example, it is possible for at least one of the sensors to be arranged in an exhaust gas aftertreatment system associated with the ammonia combustion engine.

In one variant, the amount of ammonia metered into the combustion chamber is selected via a charging and/or purging of the combustion chamber, in particular, via a valve overlap of the ammonia combustion engine.

The valve overlap can be predetermined or varied by the opening behavior:
a) of an inlet valve or a plurality of inlet valves and one outlet valve or a plurality of outlet valves of the combustion chamber of the ammonia combustion engine,
b) via an inlet slot or a plurality of inlet slots and an outlet slot or a plurality of outlet slots of the combustion chamber of the ammonia combustion engine,
c) a combination of one or more inlet slots and one or more exhaust valves of the combustion chamber of the ammonia combustion engine, or
d) a combination of one or more inlet valves and one or more outlet slots. It is also possible to also use exhaust gas recirculation (EGR).

In yet another variant, the injection device is a direct injection device, and ammonia is metered into the combustion chamber in a modified injection.

A modified injection can be realized by a longer duration of the main injection, multiple injection or additional post-injection.

If ammonia is additionally metered into the combustion chamber in a post-injection, the time of the post-injection is selected such that at least the total quantity of ammonia metered in the post-injection is no longer converted in the current cycle or combustion cycle of the ammonia combustion engine, i.e., at a point in time at which the main combustion of fuel is completed or almost completed in the current cycle or combustion cycle of the ammonia combustion engine. The ammonia metered by post-injection thus at least partially no longer functions as a fuel, but as a chemical for optimizing or simplifying the exhaust gas aftertreatment of the exhaust gas stream generated in the combustion chamber. Analogous post-injection processes are sufficiently known, for example, from diesel engines.

The fuel present in the combustion chamber is ignited, in particular, via an ignition jet. In this way, the use of alternative ignition devices such as a spark plug can be dispensed with, while at the same time, reliable ignition and defined combustion behavior can be realized. The metering of ammonia into the combustion chamber and the predetermined molar ratio present in the generated exhaust gas stream at the current operating point can thus be controlled even better by using an ignition jet.

The object is furthermore achieved according to the disclosure by an ammonia combustion engine with a combustion chamber and an injection device which is in fluidic connection with the combustion chamber and with which ammonia can be metered into the combustion chamber, wherein the ammonia combustion engine is configured to carry out the method as described above.

The features and properties of the method according to the disclosure apply correspondingly to the ammonia combustion engine according to the disclosure, and vice versa.

The object is further achieved according to the disclosure by a mobile or stationary system comprising an ammonia combustion engine as described above and an exhaust gas aftertreatment system in fluidic connection with the ammonia combustion engine for treating the exhaust gas stream generated by the ammonia combustion engine.

The mobile system can be a vehicle such as a land vehicle or a watercraft, for example a ship. The land vehicle can be road or rail-bound. However, it is also possible that it is not a road or rail-bound vehicle, for example, a vehicle in the forestry, agricultural or mining sector.

The stationary system can be a power plant for power, heat and/or cooling production. It is also possible for the stationary system to be a compression system, a pump or a system for the stationary direct drive of mechanical processes.

### BRIEF DESCRIPTION OF THE DRAWINGS

Further features and properties of the disclosure result from the following description of exemplary embodiments, which are not to be understood in a limiting sense, and from the drawings. In the figures:

FIG. 1 shows a vehicle according to the disclosure with an ammonia combustion engine according to the disclosure, and

FIG. 2 shows a schematic representation of the ammonia combustion engine according to the disclosure configured to carry out a method according to the disclosure for operating the ammonia combustion engine.

### DETAILED DESCRIPTION

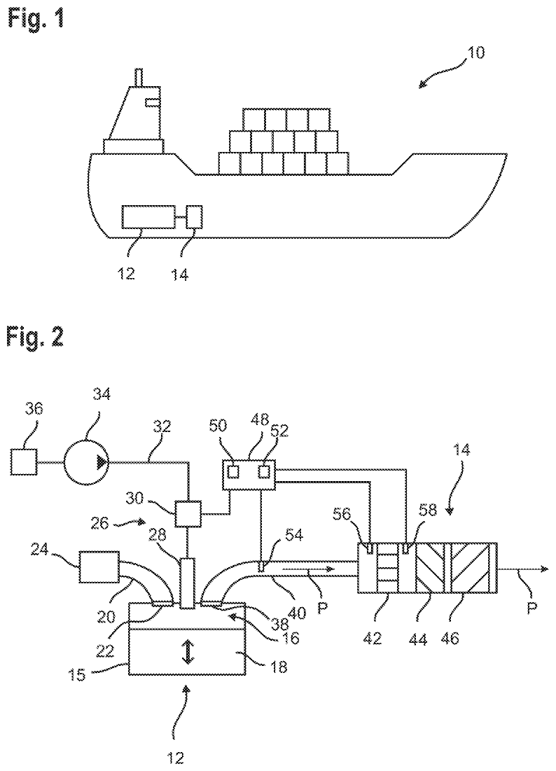

FIG. 1 shows a mobile or stationary system 10 according to the disclosure, which, in the shown embodiment, is a vehicle, specifically a watercraft, namely a cargo ship.

The mobile or stationary system 10 according to the disclosure can in principle also be different watercraft or a land vehicle, for example, a road-bound vehicle or a rail-bound vehicle. It is also possible for the mobile or stationary system 10 according to the disclosure to be a power plant.

The vehicle is driven via an ammonia combustion engine 12, i.e., via a motor which uses ammonia (NH₃) as fuel and reacts said ammonia with oxygen (O₂). Oxygen is contained in the ambient air of the ammonia combustion engine 12, which can be used directly for the combustion of ammonia.

The exhaust gas stream generated during this combustion process can, in addition to the desired reaction products of nitrogen (N₂) and water (H₂O) also contain unreacted ammonia and nitrogen oxides (NOₓ) which must be removed from the exhaust gas stream before it is released into the environment.

The generated exhaust gas stream is therefore treated with an exhaust gas aftertreatment system 14 associated with the ammonia combustion engine 12.

FIG. 2 shows further details of the ammonia combustion engine 12 according to the disclosure and of the exhaust gas aftertreatment system 14.

The ammonia combustion engine 12 has a cylinder 15 which has a combustion chamber 16 and comprises a piston 18 which is movably arranged within the cylinder 15 and is connected to a crankshaft (not shown).

Fresh air can be added to the combustion chamber 16, starting from an air supply 24, via an air supply line 20 and an air inlet valve 22. The air supply 24 is thus in fluidic connection with the combustion chamber 16.

Ammonia can be metered into the combustion chamber 16 via an injection device 26, wherein the injection device 26 comprises an injection nozzle 28 and an injection control unit 30 which are in fluidic connection with one another.

The injection control unit 30 is supplied via an ammonia supply line 32 by way of a pump 34 from a tank 36 in which ammonia is stored.

In the shown embodiment, it is a direct injection system in which air and ammonia are metered directly into the combustion chamber 16. It goes without saying that different embodiments of the ammonia combustion engine 12 can also be used. For example, an upstream mixing chamber may be provided in which ammonia and air are mixed to form an ammonia-air mixture, and the ammonia-air mixture is metered into the combustion chamber 16.

An embodiment of the ammonia combustion engine 12 may also be provided in which the ammonia-air mixture present in the combustion chamber 16 is ignited via an ignition jet.

The exhaust gas generated within the combustion chamber 16 is fed as an exhaust gas stream via an outlet valve 38 into a discharge line 40 of the ammonia combustion engine 12 and from said discharge line to the exhaust gas aftertreatment system 14, as indicated in FIG. 2 via an arrow P.

The exhaust gas aftertreatment system 14 has a first catalytic converter unit 42, a second catalytic converter unit 44, and a third catalytic converter unit 46 which are arranged in the mentioned order in the direction of flow of the exhaust gas stream.

The type and function of the catalytic converter units 42, 44 and 46 is geared to the expected chemical composition of the exhaust gas stream to convert nitrogen oxides contained in the exhaust gas stream and ammonia contained into nitrogen and water.

For example, the first catalytic converter unit 42 is a first SCR catalytic converter, the second catalytic converter unit 44 is an oxidation catalytic converter for reducing ammonia, and the third catalytic converter unit 46 is a second SCR catalytic converter.

The exhaust gas aftertreatment system 14 may also comprise a different number of and/or other types of catalytic converter units, for example additionally an N₂O decomposition catalytic converter which converts the nitrous oxide (N₂O) contained in the exhaust gas stream to nitrogen and oxygen.

The ammonia combustion engine 12 further comprises a control unit 48 which is configured to control the injection control unit 30 and is thus configured to regulate the quantity of ammonia injected into the combustion chamber 16.

The control unit 48 comprises a memory module 50 in which operating information on the behavior of the ammonia combustion engine 12 is stored.

In addition, the control unit 48 has a machine learning module 52 whose function will be discussed later.

The control unit 48 is connected to sensors 54, 56 and 58 in a signal-transmitting manner, wherein the sensor 54 is associated with the ammonia combustion engine 12, namely the discharge line 40, and the sensors 56 and 58 are associated with the exhaust gas aftertreatment system 14.

The sensor 56, viewed along the flow direction of the exhaust gas stream, is arranged upstream of the first catalytic converter unit 42 and the sensor 58 between the first catalytic converter unit 42 and the second catalytic converter unit 44.

The sensors 54, 56, and 58 sample the exhaust gas stream, it being possible to deduce the molar ratio of ammonia to nitrogen oxides in the exhaust gas stream at the location of the particular sensor 54, 56 or 58 from the sensor measurement data of the sensors 54, 56 and 58 obtained therefrom.

A method according to the disclosure for operating the ammonia combustion engine 12 is explained below.

As already described above, ammonia as a fuel is reacted with air within the combustion chamber 16. The chemical composition of the exhaust gas generated during the reaction, and thus the chemical composition of the exhaust gas stream discharged via the discharge line 40, is generally dependent on the current operating point of the ammonia combustion engine 12, for example, on the currently existing load conditions.

According to the disclosure, ammonia is metered via the injection device 26 such that the molar ratio of ammonia to nitrogen oxides in the exhaust gas stream corresponds to a predetermined molar ratio of ammonia to nitrogen oxides.

The predetermined molar ratio of ammonia to nitrogen oxides is preferably 1:1 or higher and is, in particular, within a range of 1:1 to 1.5:1, so that an equimolar ratio between ammonia and nitrogen oxides or an ammonia excess is present at any time. It is also possible to aim for a clear excess of ammonia by the predetermined molar ratio of ammonia to nitrogen oxides being 2:1 or higher, for example in the range of 2:1 to 10:1.

In another embodiment, the predetermined molar ratio of ammonia to nitrogen oxides (R) is in the range of R:1 to 1.1×R:1, wherein R is a provided NOx reduction rate. If the provided NOx reduction rate is, for example 80%, the predetermined molar ratio can be in the range of 0.8:1 to 0.88:1.

In yet another embodiment, the predetermined molar ratio is selected such that an N₂O decomposition catalytic converter used in the exhaust gas aftertreatment system 14 achieves an optimized reaction rate and selectivity.

According to the disclosure, the exhaust gas aftertreatment system 14 can thus be designed such that only exhaust gas streams having the predetermined molar ratio of ammonia to nitrogen oxides have to be handled.

In order to ensure that the predetermined molar ratio of ammonia to nitrogen oxides is present at any time in the exhaust gas stream, the following sequence of steps can take place.

First, the current operating point of the ammonia combustion engine 12 is determined, i.e., the point in the characteristic diagram of the ammonia combustion engine 12 which reflects the currently prevailing load conditions.

An expected molar ratio of ammonia to nitrogen in the exhaust gas stream generated at the current operating point is then determined.

The expected molar ratio of ammonia to nitrogen oxides can be determined on the basis of the data set stored in the memory module 50. For this purpose, the data set is based on at least one piece of operating information on the behavior of the ammonia combustion engine.

The operating information can include one or more of the following pieces of information: quantity of ammonia metered into the combustion chamber per unit of time, total quantity of ammonia metered into the combustion chamber in a combustion cycle, temporal distribution of the quantity of ammonia metered into the combustion chamber, charge air pressure, temperature, relative humidity, air-fuel ratio and ignition pressure.

In other words, based on empirical values on the behavior of the ammonia combustion engine 12, the behavior thereof at the current operating point can be estimated and, based on this, the metering of ammonia into the combustion chamber 16 can be adapted such that the exhaust gas stream has the required predetermined molar ratio of ammonia to nitrogen.

In the shown embodiment, the control unit 48 can additionally access the sensor measurement data collected by the sensors 54, 56, and 58.

In this context, the sensor 54 provides information regarding the composition of the exhaust gas stream directly after it has left the combustion chamber 16.

The sensor 56 makes it possible to determine the composition of the exhaust gas stream at the beginning of the exhaust gas aftertreatment system 14, i.e., even before the exhaust gas stream was treated by one of the catalytic converter units 42, 44 and 46.

The sensor 58 provides information regarding the composition of the exhaust gas stream after the exhaust gas stream has already passed through the first catalytic converter unit 42.

Based on the sensor measurement data of the sensors 54, 56 and 58, an estimation of the actual value of the molar ratio of ammonia to nitrogen oxides in the exhaust gas stream at the installation location of the particular sensor 54, 56 and 58 is thus possible, which can be used as an expected molar ratio.

However, it is also possible for the expected molar ratio of ammonia to nitrogen oxides to be determined at a different location within the discharge line 40 and/or the exhaust gas aftertreatment system 14 solely on the basis of the sensor measurement data obtained in the control unit 48.

In principle, the expected molar ratio of ammonia to nitrogen can also be determined solely on the basis of the data set or solely on the basis of the collected sensor measurement data. Fewer or more sensors than shown in FIG. 2 can also be used.

In the shown embodiment, the control unit 48 can update the operating information contained in the data set based on the sensor measurement data obtained by the sensors 54, 56 and 58 using the machine learning module 52, so that operating information which optimally describes the real behavior of the ammonia combustion engine 12 can be provided at any time.

The determined expected molar ratio of ammonia to nitrogen oxides is then compared with the predetermined molar ratio of ammonia to nitrogen oxides.

If the expected molar ratio deviates from the predetermined molar ratio by more than a threshold value, the amount of ammonia metered into the combustion chamber 16 via the injection device 26 is adapted such that the predetermined molar ratio of ammonia to nitrogen oxides is again established.

For example, if necessary, ammonia post-injection into the combustion chamber 16 is carried out via the injection nozzle 28 to thereby increase the proportion of ammonia in the exhaust gas stream.

The method steps described above can be repeated continuously in order to react at any time to changes in the current molar ratio of ammonia to nitrogen oxides and thus to ensure particularly reliably that the predetermined molar ratio of ammonia to nitrogen oxides is achieved.

The method according to the disclosure makes it possible to generate a controlled composition of the exhaust gas stream at any time and in this way to be able to minimize the complexity and the operating costs of the exhaust gas aftertreatment system 14 without having to accept disadvantages in the quality of the exhaust gas aftertreatment.

1. A method comprising:
operating an ammonia combustion engine with a combustion chamber and an injection device which is in fluidic connection with the combustion chamber; and
metering ammonia into the combustion chamber, such that an exhaust gas stream generated by the ammonia combustion engine has a predetermined molar ratio of ammonia to nitrogen oxides independently of a current operating point of the ammonia combustion engine.

2. The method according to claim 1, wherein the predetermined molar ratio of ammonia to nitrogen oxides is in a range of R:1 to 1.1×R:1, wherein R denotes a provided NOx reduction rate.

3. The method according to claim 1, wherein the method comprises the steps of:
a) determining the current operating point of the ammonia combustion engine;
b) determining an expected molar ratio of ammonia to nitrogen oxides in a generated exhaust gas stream at the current operating point;
c) comparing the expected molar ratio with the predetermined molar ratio; and
d) adapting a quantity of ammonia metered into the combustion chamber via the injection device if the expected molar ratio deviates from the predetermined molar ratio by more than a threshold value.

4. The method according to claim 3, wherein steps a) to d) are repeated continuously.

5. The method according to claim 3, wherein the expected molar ratio is determined on a basis of a data set stored in a control unit of the ammonia combustion engine, wherein the data set is based one at least one piece of operating information on behavior of the ammonia combustion engine.

6. The method according to claim 3, wherein the ammonia combustion engine has at least one sensor which samples a generated exhaust gas stream, and wherein the expected molar ratio is determined on a basis of sensor measurement data generated by the at least one sensor during sampling.

7. The method according to claim 1, wherein an amount of ammonia metered into the combustion chamber is selected via a charging and/or purging of the combustion chamber.

8. The method according to claim 1, wherein the injection device is a direct injection device, and ammonia is metered into the combustion chamber in a modified injection, wherein the modified injection is realized over a longer duration of a main injection, a multiple injection or an additional post-injection.

9. An ammonia combustion engine with a combustion chamber and an injection device which is in fluidic connection with the combustion chamber, and with which ammonia can be metered into the combustion chamber, wherein the ammonia combustion engine is configured to carry out the method according to claim 1.

10. A mobile or stationary system comprising an ammonia combustion engine according to claim 9 and an exhaust gas aftertreatment system which is in fluidic connection with the ammonia combustion engine, for treating the exhaust gas stream generated by the ammonia combustion engine.

11. The method according to claim 2, wherein the predetermined molar ratio of ammonia to nitrogen oxides is in the range of 1:1 or higher.

12. The method according to claim 11, wherein the predetermined molar ratio of ammonia to nitrogen oxides is in the range of 1:1 to 1.5:1.
